(19) United States
(12) Patent Application Publication
(10) Pub. No.: US 2026/0016031 A1
(43) Pub. Date: Jan. 15, 2026

(54) FIXING DEVICE WITH LONG DISPLACEMENT STROKE

(71) Applicant: HANWIT PRECISION INDUSTRIES LTD., New Taipei (TW)

(72) Inventors: Ying-Chih TSENG, New Taipei (TW); Ming-De WU, New Taipei (TW)

(21) Appl. No.: 19/252,704

(22) Filed: Jun. 27, 2025

(30) Foreign Application Priority Data
Jul. 12, 2024 (TW) 113126197

(51) Int. Cl. F16B 5/02

(52) U.S. Cl. CPC F16B 5/0283

(57) ABSTRACT

A fixing device includes an inner sleeve with a passage and a stop groove on the inside, an annular convex portion on the top and a positioning structure on the bottom, a fixing member having a head portion, a guide slope extending obliquely downward from the head portion and a coupling portion downwardly extending from the head portion and inserted into the passage of the inner sleeve, and an outer sleeve having a receiving space formed on the inside, a top surface formed on the top, a bevel groove formed on the top surface and extending obliquely inward corresponding to the opening of the receiving space and a limiting ring portion formed on the bottom and bent inward to cover the annular convex portion. This allows the fixing member to have a long vertical stroke and reduces the structural height of the fixing device.

This application claims the priority benefit of Taiwan patent application number 113126197, filed on Jul. 12, 2024.

### BACKGROUND OF THE INVENTION

### 1. Field of the Invention

The present invention is a fixing device with long displacement stroke, particularly a structural design in which the outer sleeve can be supported upward by a fixing member and the outer sleeve can form a vertical displacement on the inner sleeve, and the length of the coupling portion of the fixing member is greater than the height of the outer sleeve, so that the fixing member has a long stroke in the vertical direction. It can be used to lock a first panel member and a second panel member in an environment where there is a large distance between them, or the first panel member and the second panel member are of great thickness, and at the same time reduce the structural height of the fixing device, thereby forming a fixing device with an extremely small volume but a long stroke, which is more convenient for use in a small space such as a server room.

### 2. Description of the Related Art

Generally, when panels are assembled (panel to panel), they are locked together using a positioning screw with a knob, a collar and a screw. The screw and the collar are fixed to the first panel, and the knob is rotated to lock the screw into the second panel to form a preset positioning, and then a hand tool is used to tighten the screw to lock the first panel and the second panel into one piece. It can also be used for panel to panel connection in equipment composed of multiple devices and mechanisms, such as telecommunications cabinets, industrial computers, and machine tools.

Furthermore, some industry insiders have developed another type of fixing device that allows users to use hand tools to fix or separate panels. Please refer to FIG. 7, which is a side view of the conventional fixing device. The cap A is embedded with a screw A1 having a nut A11, and an elastic member B is sleeved on the screw A1. The cap A and the elastic member B can be assembled on a connecting holder C, and the inner hook A2 at the bottom of the cap A is hooked on the flange C1 at the top of the connecting holder C. Thus, the cap A, the elastic member B and the connecting holder C can be assembled into a fixing device D. After the buckle C2 at the bottom of the connecting holder C is embedded and fixed in the positioning plate E, the screw A1 in the cap A can be locked into the fixing plate E1 using a hand tool (such as a screwdriver or a wrench), thereby achieving the purpose of locking the positioning plate E and the fixing plate E1. Furthermore, after the fixing plate E1 is removed, the fixing device D can still be fixed in the positioning plate E by the connecting holder C without being lost.

However, the usage rate of equipment such as telecommunications office cabinets, industrial computers, and machine tools is becoming increasingly popular, and with the rapid advancement of technology, all equipment is being designed to be light, thin, short, and small. In this method of locking and fixing the positioning plate E and the fixing plate E1 by using the positioning device D, the cap A can be locked in the flange C1 of the connecting holder C through the inner hook A2 to prevent the cap A from being separated from the connecting holder C during the locking or removal operation, thereby avoiding the cap A and the screw A1 embedded inside from being lost. However, when the screw A1 is locked in the fixed plate E1, a preset length must be reserved between the bottom surface of the nut A11 and the top surface of the connecting holder C (the preset length is at least the depth of the screw A1 locked in the fixed plate E1) so that the screw A1 can be locked in the fixed plate E1. However, the cap A is buckled on the flange C1 by the inner hook A2, so the cap A needs to have a certain height according to the preset length, which will occupy the space inside each device, resulting in interference with the use of the remaining electronic components inside, thereby making the internal space of each device insufficient.

Therefore, how to solve the above-mentioned shortcomings and inconveniences is the direction that the relevant practitioners in this industry are eager to study and improve.

### SUMMARY OF THE INVENTION

Therefore, in view of the above problems and deficiencies, the inventor collected relevant information and, after multiple evaluations and considerations, designed the invention of this fixing device with long displacement stroke.

The main object of the present invention is to provide a fixing device with long displacement stroke, which comprises an inner sleeve comprising an inner sleeve body, a passage and a stop groove formed inside the inner sleeve body, an annular convex portion formed on the top side of the inner sleeve body and expanding outward, and a positioning structure formed on the bottom side of the inner sleeve body; a fixing member comprising a head portion, a guide slope extending obliquely downward from the edge of the head portion, and a coupling portion downwardly extending from the bottom side of the head portion and inserted into the passage of the inner sleeve; and an outer sleeve comprising an outer sleeve body, a receiving space formed inside the outer sleeve body, a top surface formed on a top side of said outer sleeve body, a bevel groove formed on the top surface and extending obliquely inward corresponding to the opening of the receiving space, and a limiting ring portion formed on the opposing bottom side of the outer sleeve body and bent inward to cover the annular convex portion of the inner sleeve. This allows the fixing member to have a long vertical stroke and reduces the structural height of the fixing device. By unlocking the fixing member upward, the guide slope and bevel groove can be positioned to interfere with each other, and the outer sleeve can be moved upward on the inner sleeve. When the fixing member is moved downward and locked, the bottom side of the head portion is abutted and positioned at the stop groove of the inner sleeve, and the outer sleeve forms a downward displacement on the inner sleeve, and the top surface of the outer sleeve has the bottom side thereof abutted against the annular convex portion of the inner sleeve. The fixing member can be used to support the outer sleeve upward and the outer sleeve can form a vertical displacement on the inner sleeve, and the length of the coupling portion of the fixing member is greater than the height of the outer sleeve, so that the fixing member has a long stroke in the vertical direction. It can be used to lock the first panel member and the second panel member in an environment where there is a large distance between them, or the first panel member and the second panel member are of great thickness, and at the same time reduce the structural height of the fixing device, thereby forming a fixing device with an extremely small volume but a long stroke, which is more convenient for use in a small space such as a server room.

Another object of the present invention is that the positioning structure of the inner sleeve comprises a striking portion located at the bottom side of the inner sleeve body and fixed to a first fixing hole of a preset first panel member by riveting by punching, and the striking portion extends downward to have a retaining portion with a smaller diameter, and an inwardly recessed annular groove is provided between the striking portion and the retaining portion.

Still another object of the present invention is to form an operating slot in the top surface of the head portion of the fixing member for inserting a preset hand tool into the operating slot for locking and unlocking. The operating slot can be in the shape of a straight line, a cross, a hexagon, a star or a plum blossom.

### BRIEF DESCRIPTION OF THE DRAWINGS

FIG. 1 is a three-dimensional external view of the fixing device of the present invention.

FIG. 2 is a three-dimensional external view of the fixing device of the present invention from another viewing angle.

FIG. 3 is a three-dimensional exploded view of the fixing device of the present invention.

FIG. 4 is a three-dimensional exploded view of the fixing device of the present invention from another viewing angle.

FIG. 5 is a side cross-sectional view of the fixing device of the present invention in an unlocked state.

FIG. 6 is a side cross-sectional view of the fixing device of the present invention in a locked state.

FIG. 7 is a side cross-sectional view of a conventional fixing device.

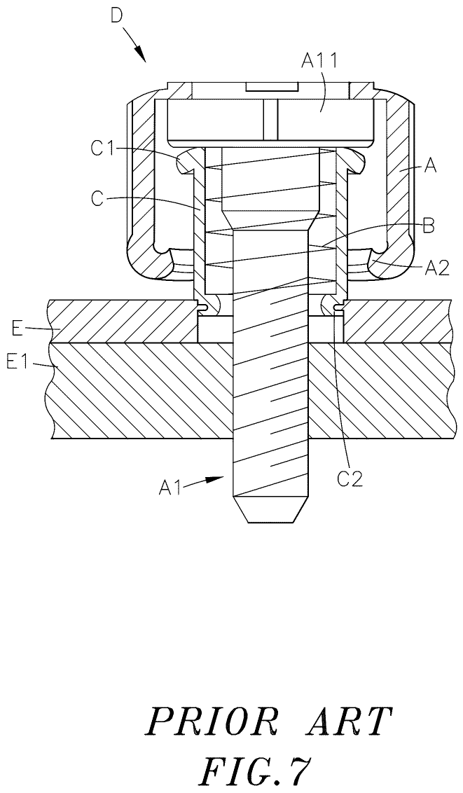

### DETAILED DESCRIPTION OF THE INVENTION

In order to achieve the above objects and effects, the technical means and structures adopted by the present invention are described in detail below with respect to the preferred embodiment of the present invention, so as to facilitate a complete understanding.

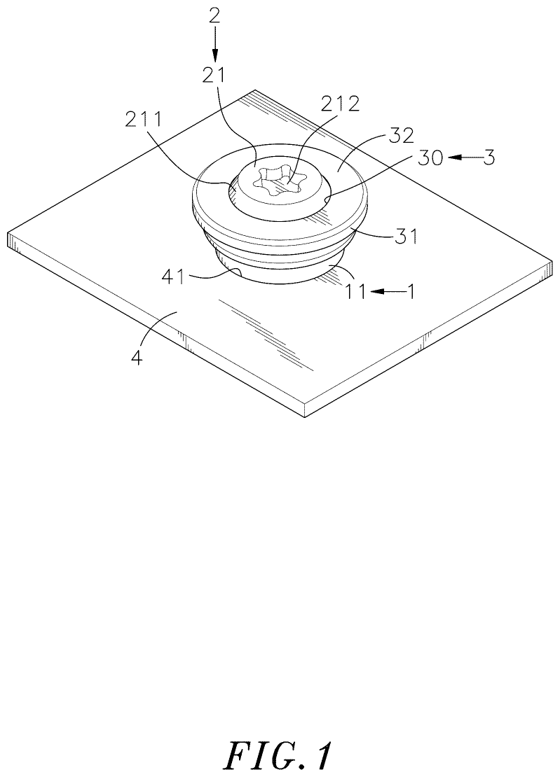

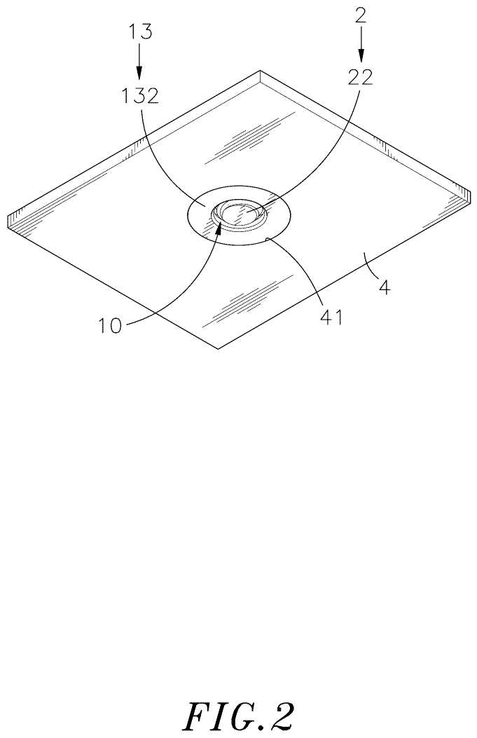

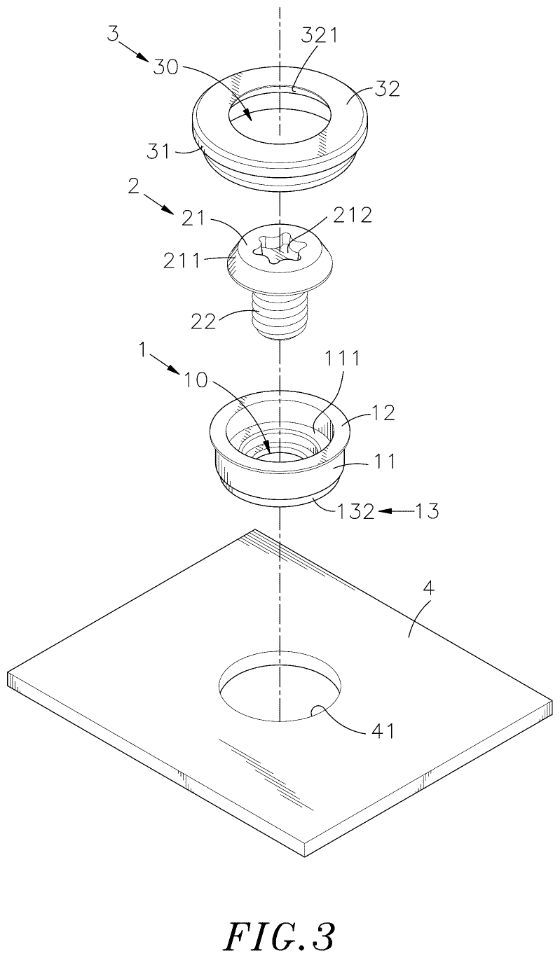

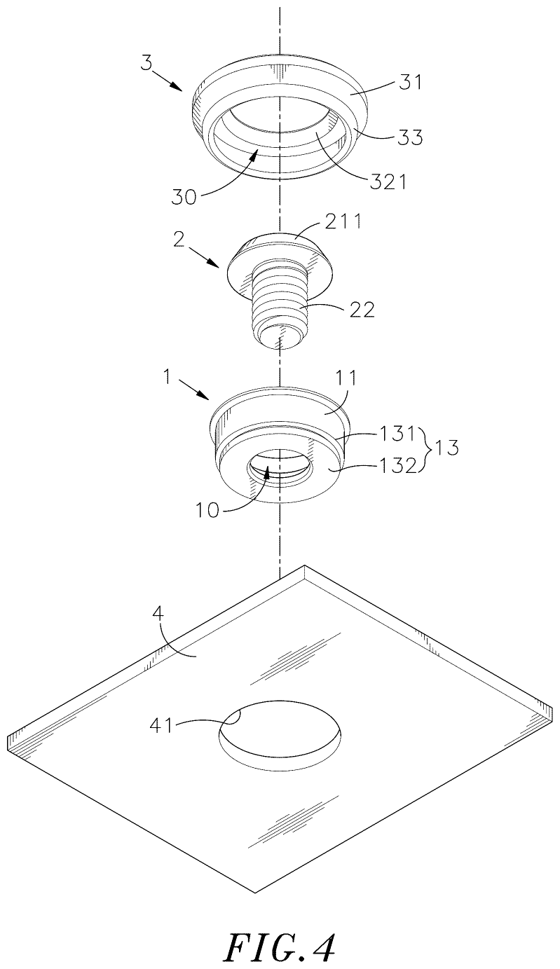

Please refer to FIGS. 1 to 6, which are respectively a three-dimensional external view, a three-dimensional external view from another viewing angle, a three-dimensional exploded view, a three-dimensional exploded view from another viewing angle, a side cross-sectional view in an unlocked state, and a side cross-sectional view in a locked state of the fixing device of the present invention. As can be clearly seen from the figures, the fixing device of the present invention mainly comprises an inner sleeve 1, a fixing member 2 and an outer sleeve 3, and its main components and features are described in detail as follows:

The inner sleeve 1 comprises an inner sleeve body 11, a passage 10 and a stop groove 111 formed inside the inner sleeve body 11, an annular convex portion 12 formed on the top side of the inner sleeve body 11 and expanding outward, and a positioning structure 13 formed on the bottom side of the inner sleeve body 11.

The fixing member 2 comprises a head portion 21, a guide slope 211 extending obliquely downward from an edge of the head portion 21, and a coupling portion 22 downwardly extending from the bottom side of the head portion 21 and inserted into the passage 10 of the inner sleeve 1.

The outer sleeve 3 comprises an outer sleeve body 31, a receiving space 30 formed inside the outer sleeve body 31, a top surface 32 formed on the top side of the outer sleeve body 31, a bevel groove 321 formed on the top surface 32 and extending obliquely inward corresponding to the opening of the receiving space 30, and a limiting ring portion 33 formed on the bottom side of the outer sleeve body 31 and bent inward to cover the annular convex portion 12 of the inner sleeve 1. When the fixing member 2 is unlocked and moved upward, an interference positioning between the guide slope 211 and the bevel groove 321 is formed, and the outer sleeve 3 is moved upward on the inner sleeve 1. When the fixing member 2 is moved downward and locked, the bottom side of the head portion 21 is abutted and positioned at the stop groove 111 of the inner sleeve 1, and the outer sleeve 3 forms a downward displacement on the inner sleeve 1, and the bottom side of the top surface 32 of the outer sleeve 3 is abutted against the annular convex portion 12 of the inner sleeve 1.

The positioning structure 13 of the inner sleeve 1 comprises a striking portion 131 located at the bottom side of the inner sleeve body 11 and riveted to a first fixing hole 41 of a first panel member 4 by punching, a retaining portion 132 with a relatively smaller diameter extending downward from the striking portion 131 and abutted with the outer wall thereof against the first fixing hole to prevent the inner sleeve 1 fixed on the first panel member 4 from being skewed or falling off, and an inwardly recessed annular groove 133 provided between the striking portion 131 and the retaining portion 132 for accommodating the material of the first panel member 4 cut and deformed by the striking portion 131 to make the fixing structure between the inner sleeve 1 and the first panel member 4 more stable.

The top surface of the head portion 21 of the fixing member 2 is recessed to form an operating slot 212 for a preset hand tool (not shown) to enter for locking and unlocking. The operating slot 212 can be in the shape of a straight line, a cross, a hexagon, a star or a plum blossom. The head portion 21 of the fixing member 2 and the bevel groove 321 of the outer sleeve 3 both have a trapezoidal cross-sectional structure in side view. When the fixing member 2 is unlocked and moved upward, the outer edge of the guide slope 211 and the center of the bevel groove 321 can form an interference positioning. The outside of the coupling portion 22 of the fixing member 2 has an external thread locked into the second fixing hole 51 of the preset second panel member 5. The length of the coupling portion 22 of the fixing member 2 is greater than the height of the outer sleeve 3, so that the fixing member 2 has a long stroke displacement in the vertical direction and the structural height of the fixing device is reduced.

When the fixing device of the present invention is to be assembled, the coupling portion 22 of the fixing member 2 is first inserted into the passage 10 of the inner sleeve 1 from top to bottom, so that the fixing member 2 is accommodated in the inner sleeve 1, then the outer sleeve 3 is covered over the inner sleeve 1 to form a pre-positioned state, and an extrusion jig (not shown) is used to squeeze the lower edge of the outer sleeve body 31 of the outer sleeve 3 and bend it inward to form the limiting ring portion 33, and to cover the annular convex portion 12 of the inner sleeve 1, so that the outer sleeve 3 forms a fixed structure that will not separate from the inner sleeve 1. The assembly of the fixing device is completed through the above steps.

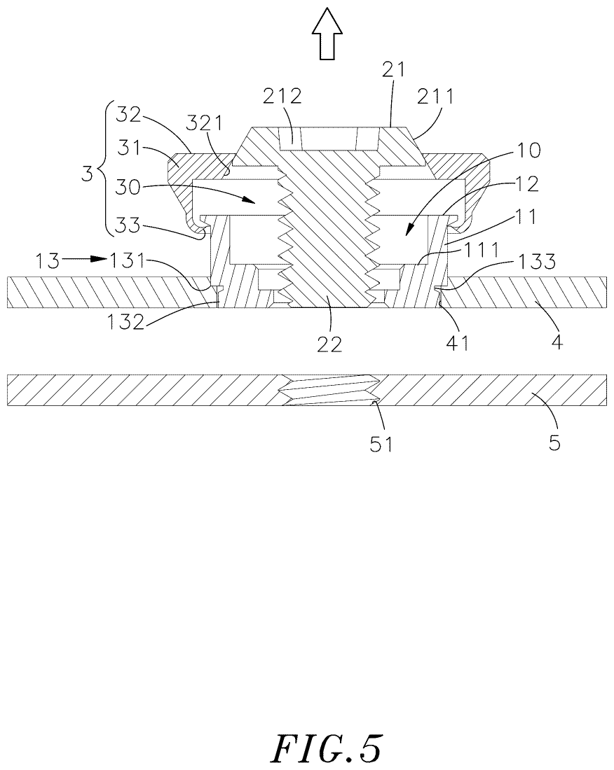

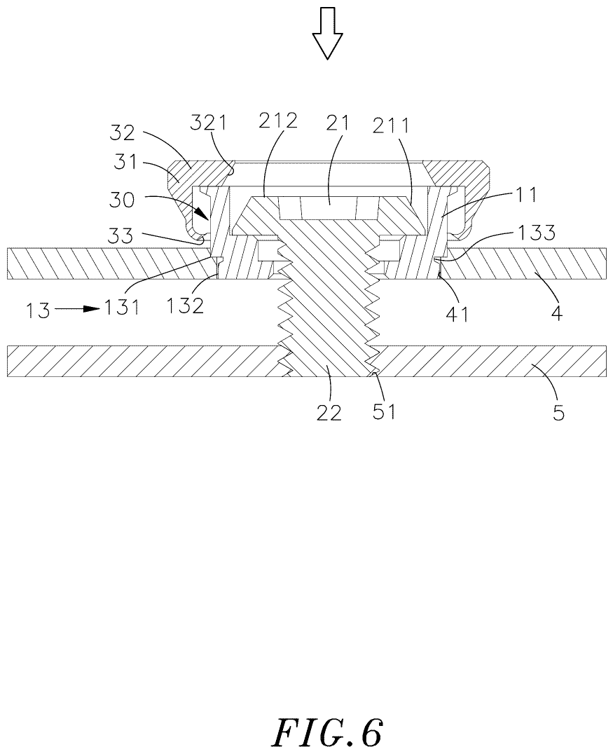

Please refer to FIGS. 5 and 6, which are side cross-sectional views of the fixing device of the present invention in an unlocked state and a side cross-sectional view in a locked state. When fixing the fixing device to the first panel member 4, the retaining portion 132 of the inner sleeve 1 needs to be aligned and inserted into the first fixing hole 41 to form a pre-positioning, then, a punching jig (not shown) is used to impact the top surface 32 of the outer sleeve 3 from top to bottom, so that the top surface 32 of the outer sleeve 3 is pressed against the annular convex portion 12 of the inner sleeve 1 to generate a downward impact force, and the striking portion 131 of the inner sleeve 1 having a diameter slightly larger than the first fixing hole 41 generates a downward cutting force to form a riveting. The inwardly recessed annular groove 133 located below the striking portion 131 can receive the material of the first panel member 4 cut by the striking portion 131 to form an interference structure, and make the fixing structure between the inner sleeve 1 and the first panel member 4 more stable. The second panel member 5 is disposed below the first panel member 4 and has a larger spacing. When the fixing member 2 is locked and moved downward, the bottom side of the head portion 21 can be held and positioned at the stop groove 111 of the inner sleeve 1, and the outer sleeve 3 can form a downward displacement on the inner sleeve 1, so that the coupling portion 22 of the fixing member 2 can be locked downward in the second fixing hole 51 of the second panel member 5. The length of the coupling portion 22 of the fixing member 2 is greater than the height of the outer sleeve 3, so that the fixing member 2 has a long stroke displacement in the vertical direction. When the fixing member 2 is unlocked and moved upward, the guide slope 211 and the bevel groove 321 can form an interference positioning, and the outer sleeve 3 can form an upward displacement on the inner sleeve 1, so that the coupling portion 22 of the fixing member 2 has sufficient stroke to be unlocked and disengaged from the second fixing hole 51 of the second panel member 5, thereby separating the first panel member 4 and the second panel member 5.

The main features of the present invention are that the fixing member 2 can be used to support the outer sleeve 3 upward and the outer sleeve 3 can form a vertical displacement on the inner sleeve 1, and the length of the coupling portion 22 of the fixing member 2 is greater than the height of the outer sleeve 3, so that the fixing member 2 has a long stroke in the vertical direction. It can be used to lock the first panel member 4 and the second panel member 5 in an environment where there is a large distance between them, or the first panel member 4 and the second panel member 5 are of great thickness, and at the same time reduce the structural height of the fixing device, thereby forming a fixing device with an extremely small volume but a long stroke, which is more convenient for use in a small space such as a server room.

The above is only a preferred embodiment of the present invention, and does not limit the patent scope of the present invention. Therefore, all simple modifications and equivalent structural changes made by using the contents of the description and drawings of the present invention should be included in the patent scope of the present invention and should be declared.

As mentioned above, the fixing device with long displacement stroke of the present invention can achieve its effect and purpose when used, so the present invention is truly an invention with excellent practicality. In order to meet the application requirements for invention patents, we have filed an application in accordance with the law. We hope that the review committee will approve this case as soon as possible to protect the inventor's hard work in research and development. If the review committee has any questions, please feel free to write to us for instructions. The inventor will do his best to cooperate and will be grateful for the convenience.

What is claimed is:

1. A fixing device with long displacement stroke, comprising:
an inner sleeve comprising an inner sleeve body, a passage and a stop groove formed inside said inner sleeve body, an annular convex portion formed on a top side of said inner sleeve body and expanding outward, and a positioning structure formed on an opposing bottom side of said inner sleeve body;
a fixing member comprising a head portion, a guide slope extending obliquely downward from an edge of said head portion, and a coupling portion downwardly extending from a bottom side of said head portion and inserted into said passage of said inner sleeve; and
an outer sleeve comprising an outer sleeve body, a receiving space formed inside said outer sleeve body, a top surface formed on a top side of said outer sleeve body, a bevel groove formed on said top surface and extending obliquely inward corresponding to an opening of said receiving space, and a limiting ring portion formed on an opposing bottom side of said outer sleeve body and bent inward to cover said annular convex portion of said inner sleeve;
wherein when said fixing member is unlocked and moved upward, an interference positioning between said guide slope and said bevel groove is formed, and said outer sleeve is moved upward on said inner sleeve; when said fixing member is moved downward and locked, the bottom side of said head portion is abutted and positioned at said stop groove of said inner sleeve, and said outer sleeve forms a downward displacement on said inner sleeve, and said top surface of said outer sleeve has a bottom side thereof abutted against said annular convex portion of said inner sleeve.

2. The fixing device with long displacement stroke as claimed in claim 1, wherein said positioning structure of said inner sleeve comprises a striking portion located at a bottom side of said inner sleeve body and riveted to a first fixing hole of a first panel member by punching, a retaining portion with a relatively smaller diameter extending downward from said striking portion, and an inwardly recessed annular groove provided between said striking portion and said retaining portion.

3. The fixing device with long displacement stroke as claimed in claim 1, wherein said head portion of said fixing member has a top surface thereof recessed to form an operating slot for a preset hand tool to enter for locking and unlocking, said operating slot being selectively in the shape of a straight line, a cross, a hexagon, a star or a plum blossom.

4. The fixing device with long displacement stroke as claimed in claim 1, wherein said head portion of said fixing member and said bevel groove of said outer sleeve both have a trapezoidal cross-sectional structure in side view, so that when said fixing member is unlocked and moved upward, an outer edge of said guide slope and the center of said bevel groove form an interference positioning.

5. The fixing device with long displacement stroke as claimed in claim 1, wherein said coupling portion of said fixing member is externally provided with an external thread for locking into a second fixing hole on a preset second panel member.

6. The fixing device with long displacement stroke as claimed in claim 1, wherein a length of said coupling portion of said fixing member is greater than a height of said outer sleeve, so that said fixing member has a long stroke displacement in the vertical direction and the structural height of the fixing device is reduced.
